(19) United States
(12) Patent Application Publication
(10) Pub. No.: US 2024/0228329 A1
(43) Pub. Date: Jul. 11, 2024

(54) LIGHT-BASED DISINFECTION AND/OR SANITIZATION OF A SUBSTANCE

(71) Applicant: Kart Kleen LLC, Missoula, MT (US)

(72) Inventor: Jason Gardiner, Missoula, MT (US)

(73) Assignee: Kart Kleen LLC, Missoula, MT (US)

(21) Appl. No.: 18/528,735

(22) Filed: Dec. 4, 2023

Related U.S. Application Data
(60) Provisional application No. 63/455,949, filed on Mar. 30, 2023.
(60) Provisional application No. 63/438,215, filed on Jan. 10, 2023.

(51) Int. Cl. C02F 1/32

(52) U.S. Cl. CPC C02F 1/32; C02F 2201/3221; C02F 2201/3227; C02F 2303/04

(57) ABSTRACT

A device receives a liquid from a machine and treats the liquid prior to returning the liquid to the machine. One or more lamps of the device emit light (e.g., UV light, UV-C light, etc.) directed towards the liquid while within the device in order to clean, sanitize, or disinfect the liquid, to remove an odor associated with the liquid, to change a color of the liquid, and/or to remove pathogens or other unwanted substances from the liquid.

### CROSS-REFERENCE TO RELATED APPLICATIONS

This application claims priority to, co-pending, commonly-owned U.S. Provisional Patent Application No. 63/455,949 filed on Mar. 30, 2023, and U.S. Provisional Patent Application No. 63/438,215 filed on Jan. 10, 2023, each of which is incorporated herein in its entirety by reference.

### BACKGROUND

On a daily basis, people physically contact, without protection, potentially contaminated objects, and surfaces of such objects. Objects may include door handles, tables, rails, benches, shopping carts, seats within a vehicle, and the like. For instance, as a result of people riding in, or touching, seats or other surfaces of a vehicle, these surfaces are exposed to various types of pathogens, including viruses, bacteria, and so on. When the next person rides in the vehicle, the pathogens may be unintentionally passed to that person, possibly resulting in sickness or death. The likelihood of illness is significantly high considering the type and number of vehicles that include seats touched by different people on a daily basis, including cars (e.g., personal cars, rideshare cars, police cars, ambulances, fire trucks/engines, taxi cabs, etc.), busses, trains, airplanes, commuter vans, shuttles, and so on. Accordingly, there is a need to sanitize and disinfect various objects and surfaces of such objects.

In addition, viruses, fungus, bacteria, DNA, RNA, drugs (e.g., narcotics, opioids, fentanyl, methamphetamines, etc.), and other harmful pathogens (collectively referred to herein as “pathogens”) may be found on and/or within various types of surfaces and/or machines. In some machines, a liquid or coolant used in association with the machine, or that is a byproduct of the operation of the machine, may be contaminated with such pathogens. Presence of the pathogens may contaminate materials that are treated, processed, manufactured, output, etc. by the machines. A non-exhaustive list of examples of machines that may experience contamination may include manufacturing machines (e.g., computer numerical control (“CNC”) machines), lathes, food separator machines, dairy machines, cutting machines, meat separators, agricultural belts, corn bailers, hay bailers, farm combines, etc.). Removal of the pathogens and disinfection/sanitization of machines, or liquids, coolants, substances, surfaces, etc. associated therewith, may reduce the inadvertent transmission of pathogens to people, other machines, other parts/components of the machines, animals, or other inanimate objects. Moreover, removal of the pathogens may also allow the machines to operate in a cleaner manner, may result in a reduced amount of maintenance for the machines, may reduce the extent to which the liquids/coolants need to be cleaned or replaced, and may increase the longevity of the machines, thereby allowing the machines to operate for longer/extended periods of time.

### BRIEF DESCRIPTION OF THE DRAWINGS

The detailed description is set forth with reference to the accompanying figures. In the figures, the left-most digit(s) of a reference number identify the figure in which the reference number first appears. The use of the same reference numbers in different figures indicates similar or identical items or features.

FIG. 1 is a pictorial diagram of an illustrative machine or device in which a liquid or substance associated therewith is to be sanitized or disinfected.

FIG. 2 is a pictorial diagram of the machine or device as depicted in FIG. 1 with respect to the liquid or the substance that is to be sanitized or disinfected.

FIG. 3 is a pictorial diagram of the machine or device as depicted in FIG. 1, including one or more lamps that emit light directed towards the liquid or substance in order to sanitize or disinfect the liquid or substance.

FIG. 4 is a pictorial diagram of the machine or device as depicted in FIG. 1 after the one or more lamps have emitted light directed towards the liquid or substance, thereby sanitizing or disinfecting the liquid or substance.

FIG. 5 is a pictorial diagram of an illustrative device that is integrated within a machine in order to disinfect or sanitize a liquid or substance.

FIG. 6 is a pictorial diagram of the device and machine as depicted in FIG. 5, where one or more lamps of the device are emitting light directed towards a liquid associated with the machine.

FIG. 7 is a pictorial diagram of the device as depicted in FIG. 5, from a side perspective.

FIG. 8 is a pictorial diagram of the device as depicted in FIG. 5, from a perspective of the end of the device.

FIG. 9 is a pictorial diagram of the device as depicted in FIG. 5, from multiple different perspectives.

FIG. 10 is a pictorial diagram of an illustrative device and a corresponding container utilized to sanitize or disinfect a liquid, substance, or object.

FIG. 11 is a pictorial diagram of the device as depicted in FIG. 10, from multiple different perspectives.

FIG. 12 is a pictorial diagram of a system utilized to sanitize or disinfect a liquid.

FIG. 13 is a pictorial diagram of a system utilized to sanitize or disinfect a liquid.

FIG. 14 is a pictorial diagram of the device as depicted in FIG. 13, from a different perspective.

FIG. 15 is a pictorial diagram of a component of the device as depicted in FIG. 13.

### DETAILED DESCRIPTION

The system and processes described herein are directed to a device for sanitizing and disinfecting surfaces and/or objects, such as machines, liquids, coolants, or other substances associated with the machines, surfaces of the machines, etc., using light emitted onto the surfaces. For the purposes of this disclosure, the item to be sanitized may be interchangeably referred to as machine, liquid, substance, object, surface, etc. The light may include ultraviolet (UV) light, UV-C light, and any other type of light that is capable of killing/eliminating pathogens (collectively referred to as “light”) that is emitted by UV lamps, UV-C lamps, and any other lamps/lights that emit the light (collectively referred to as “lamps”).

The device may include one or more lamps that are configured to apply/emit light onto one or more surfaces associated with a machine or equipment (collectively referred to herein as “machine”), such as various components of the machine, surfaces/items that are treated, processed, or manufactured by the machine, and/or liquids/coolants used or output by the machine, or liquids/coolants that are otherwise used or associated with the machine. For instance, liquids, substances, or surfaces of a machine that are dirty, contaminated, used, etc. may be exposed by light emitted by the lamp(s) of the device. The light may sanitize or disinfect the liquids, substances, surfaces, etc. of the machine. In some instances, once sanitized or disinfected by the light emitted by the lamp(s) of the device, the liquids, substances, surfaces, etc. associated with the machine may be used, reused, or again become usable. The device may be external to the machine, be placed into or within the machine, be placed over the machine, and/or be integrated into the machine.

The device may have two or more rotatable and pivotable arms that each have one or more lamps that emit light towards a liquid, object, substance, surface, etc. However, in other embodiments, and as shown in this application, the device may have a single arm having at least one lamp (and a single lamp in certain embodiments). The device may have one or more legs that are attached to opposite ends of the arm and that allow the device to be disposed on a surface. If not disposed on opposite ends of the device, the legs are spaced apart from one another such that the legs support and allow the device to be positioned in an upright configuration. Presence of the legs causes the existence of a space/gap between the lamp(s) and the surface (or liquid, object, substance, etc.) in which the lamp(s) emit light towards. As a result, by disposing the device on a surface, objects, liquids, substances, etc. to be sanitized/disinfected may be placed on the surface in which the device is positioned and underneath the lamp(s). The lamp(s) of the device may also sanitize/disinfect the surface that is underneath the device/lamp(s) and/or a liquid/coolant situated underneath, or passing beneath, the lamp(s).

In the embodiment described directly above, the device may consist of a single fixed lamp (although multiple lamps may be present) and a ballast assembly, as opposed to a pivoting/rotating ballast assembly having multiple fixed lamps. A reduction of size of the device may allow the device to be placed or disposed within various machines in order to sanitize/disinfect the machine itself, various components of the machine, and/or a liquid (e.g., machine coolant) or substance associated with, used by, output by, etc. the machine. The liquid, coolant, substance, etc. may be used by, produced by, manufactured by, etc. the machine.

The device may be situated such that the lamp(s) emit light toward a liquid, substance, or surface contained within, or in connection with, a machine, such as a coolant, in order to sanitize/disinfect the liquid and remove pathogens/contaminants from the liquid. The liquid may be within the machine or may be exterior to the machine. The liquid may be utilized to cool the machine or may be a byproduct of use of the machine. For instance, in the context of a lathe (e.g., a manual lathe), a coolant used in association with the lathe may have poor color or quality. The device may be positioned within the lathe such that the lamp(s) of the device emit light towards the coolant, thereby sanitizing/disinfecting the coolant, removing/destroying contaminants or pathogens within the coolant, and improving the color, odor, quality, and/or cleanliness of the coolant. As another example, the device/lamp(s) may be used to clean, disinfect, decontaminate, sanitize, etc. cutting fluids contained within retention or storage tanks that collect machine cutting fluids output by various machines, such as machines included in machine shops.

The device may be positioned within the machine such that the legs are disposed on a surface of a component of the machine. In other instances, the arm/lamp(s) may be attached to a surface of the machine (e.g., top surface, side surface, etc.) not using the legs of the device, or the legs may be removed from the device prior to attaching the device to the surface of the machine. For example, the device may be disposed above the item/surface/liquid that is to be disinfected/sanitized, such that the device is suspended over the item/surface/liquid. Alternatively, or in addition, the device may be disposed on a side surface such that light may be emitted in different directions/configurations with respect to the item/surface/liquid to be decontaminated. The device may be attached in any manner, including straps, adhesive, tape, rope, string, Velcro, clips, screws, nails, cords, and so on. In this scenario, the device may be suspended above a coolant residing in a coolant reservoir or a coolant trough of the machine.

Moreover, in some embodiments, the device may be positioned such that the lamp(s) emit light toward a surface of a component of the machine that is to be sanitized and/or disinfected. For instance, the device/lamp(s) may be positioned such that the light is emitted towards a surface that potentially includes pathogens, possibly as a result from the functioning of a machine.

Instead of utilizing legs of the device, the arm/lamp(s) assembly of the device may be enclosed within a container, box, bag, etc. (collectively referred to herein as “container”) that is to be used to sanitize/disinfect an item and/or liquid. In this embodiment, the arm/lamp(s) of the device may be attached, secured, or affixed to an internal surface of the container. For example, the device may be affixed to a top interior surface (or any other interior surface) of the container. In this configuration, the lamp(s) of the device may emit light towards the item/surface/liquid to be treated. The device being disposed within the container may prevent the light from being emitted external to the interior/cavity of the container. When the container is placed over the item/surface/liquid to be sanitized, the surfaces of the container may prevent the light from escaping the interior of the container. That is, the walls and top of the container may be made of a material that is not clear, translucent, or opaque (e.g., cardboard, metal, plastic, fabric, etc.). The container may have not bottom surface such that the container can be placed over the item/surface/liquid to be sanitized. In some embodiments, the container may lack a side wall/surface such that the container can be placed to the side of the item/surface/liquid to be sanitized. In this embodiment, the lamp(s) may be disposed on any interior surface of the container.

Instead of the device being affixed to an interior surface of the container, the container may alternatively have a cut-out, void, or hole consistent with the size/shape of the device such that the lamp(s) is/are able to emit light within the interior of the container. The cut-out, void, or hole may be disposed on the top surface of the container such that the light is emitted downwards toward the item/surface/liquid to be sanitized. The container may be placed over an object or liquid that is to be sanitized/disinfected such that the object/coolant is exposed to the light emitted by the lamp(s). For instance, the container may be placed over a coolant reservoir or coolant trough of a machine, such as a lathe, mill, etc. In other embodiments, the cut-out, void, or hole may be disposed on a side surface of the container such that the light emitted by the lamp(s) is/are directed in a substantially horizontal direction towards a top surface, a side surface, and/or a bottom surface of the item/surface/liquid to be sanitized. In this scenario, the container may be placed to the side of the item/surface/liquid to be sanitized.

As stated herein, the device and associated lamp(s) may emit light towards, and disinfect/sanitize/decontaminate, any type of machine, device, item, object, liquid, appliance, surface, etc. in any field or industry. Additional examples of types of liquids in which the device/lamp(s) apply light towards may include water associated with water purification, sewage associated with sewage treatment, processed, unprocessed, or partially processed milk associated with milk processing, and so on. The device may also be used in association with toilet/urinal sanitization, sanitization of surfaces, appliances, tools, utensils, etc. in associated with kitchens, including commercial kitchens (e.g., restaurants, food preparation, food distribution, etc.), sanitization of silverware and/or drinking glasses, and/or the sanitization of beverage stations, including beer taps, soda fountain machines, etc.

The device may be powered and operated by plugging the device into an outlet, such as a GFCI outlet. Provided that the device is being used to sanitize/disinfect an object/liquid/surface associated with a machine, the device may be plugged into an outlet associated with the machine (e.g., built into the back of the machine). For instance, various CNC machines have an outlet in which the device may be plugged into. In some embodiments, provided that the device is plugged into the machine, once the machine is powered on, the device will be powered on and the lamp(s) may begin emitting light. Likewise, when the machine is powered off, the device and corresponding lamp(s) will be powered off. For manual machines, however, the lamp(s) may need to be manually turned on and off via plugging and unplugging the device from the outlet, or by actuating a button, switch, lever, etc. disposed on the device itself. In situations where the device is not plugged directly into a machine, the device may be plugged into any outlet. Additional details regarding how the device is powered on/off and the duration in which the lamp(s) emit light are described herein.

The extent to which the object, surface, fluid, etc. is decontaminated, cleaned, disinfected or sanitized can be documented by capturing photographs before and after the lamp(s) of the device emit the light directed towards the object/surface/liquid. Decontamination of surfaces/fluids may decrease potential odor associated with the machine/liquid, may improve the longevity of the fluid, may reduce costs to clean the machine/liquid, and may reduce the cost and burden associated with replacement of the machine/liquid, which may include draining the system/machine, cleaning the tank(s)/lines of the machine, and purchasing and filling the replacement fluids. Use of the device may also eliminate the extent of fluids, coolants, waste cutting fluids, etc. that are introduced into the water system, and may improve the health and safety of individuals that are exposed to contaminated or dirty fluids.

In some embodiments, the device may be a coolant decontamination unit (“CDU”) that is configured to fit machining units of larger and/or varying sizes. The CDU may have a float and suction line that may skim the coolant/oil from a coolant reservoir. At that point, the coolant/oil may be pumped up into a UV light area and a skimmer wheel. The coolant/oil may be skimmed and collected (to be dumped elsewhere) and the excess/extra coolant/oil may be returned to the original coolant reservoir. A pump that pumps the coolant/oil into the UV light area may be operated from a first gear (of any size) that meshes or that coincides with a second gear that may correspond to an oil skimmer gear. In some embodiments, the second gear may be larger than the first gear, or vice versa, or the first/second gears may be approximately the same shape/size. In embodiments where the pump is not operated in association with one or more gears, the pump may be an electric pump that is operated via electric power. The coolant/oil may be continually cycled by the CDU and, therefore, an entirety of the coolant/oil may be exposed to UV light over time.

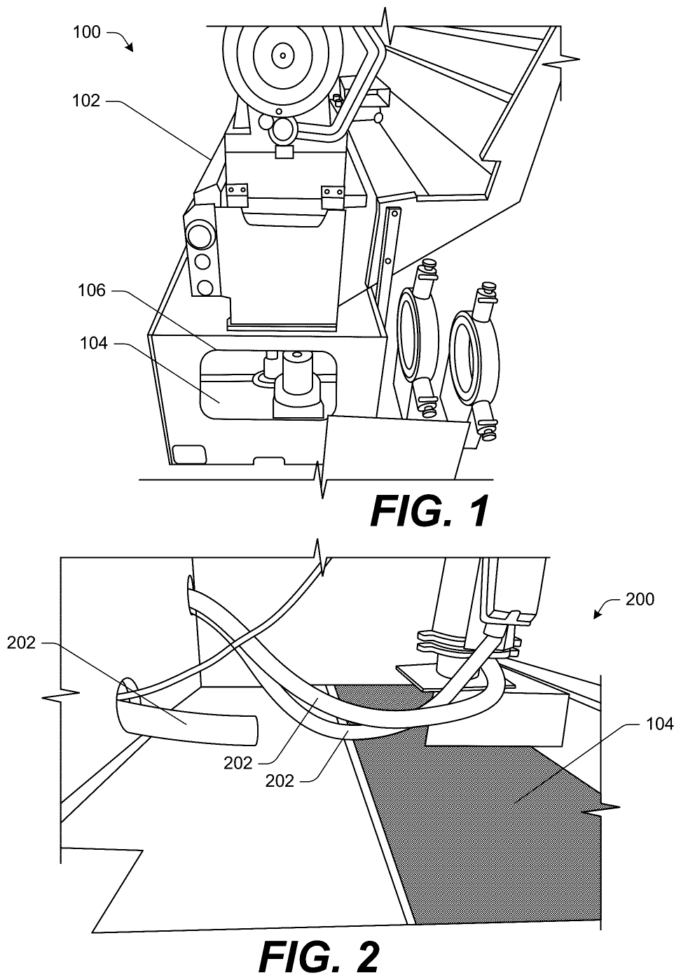

FIG. 1 is an example diagram 100 that depicts a machine 102. The machine 102 may be of any type of machine, including a manual lathe. In some embodiments, the machine 102 may be infrequently used, may be in poor condition, may have dirty surfaces, and/or may have a liquid (e.g., a coolant) that has poor color, poor quality, and/or poor or unpleasant odor. As shown in FIG. 1, the machine 102 (e.g., a manual lathe) may have a liquid 104 (e.g., a coolant) that is disposed in a reservoir 106, such as a coolant reservoir 106, and that is of poor quality, odor, and/or color. As a result, the machine 102 may not operate in its intended manner, may be prone to breakage or poor performance, may cause messy conditions, may clog various hoses or other components of the machine 102, and so on. As a result, it would be helpful and beneficial for the liquid 104 to be cleaned, sanitized, disinfected, etc. However, due to the liquid 104 being disposed within the machine 102, it may be difficult to clean, sanitize, and/or disinfect the liquid 104 without replacing the liquid 104, such as removing the liquid 104 from the machine 102 and adding new liquid 104.

FIG. 2 is an example diagram 200 that depicts a portion of the machine 102 depicted in FIG. 1. In particular, the machine 102 includes the liquid 104 in the reservoir 106, where the liquid 104 is shown to be in a darkened state indicating that the liquid 104 is dirty, is in poor condition, has an unpleasant odor, is of poor color, is of poor quality, needs to be cleaned and/or replaced, and so on. Also shown in FIG. 2 are one or more tubes or pipes 202 that transport the liquid 104 into this portion/compartment of the machine 102, transport the liquid 104 away from this portion/compartment of the machine 102, or circulate the liquid 104 to different portions/components of the machine 102.

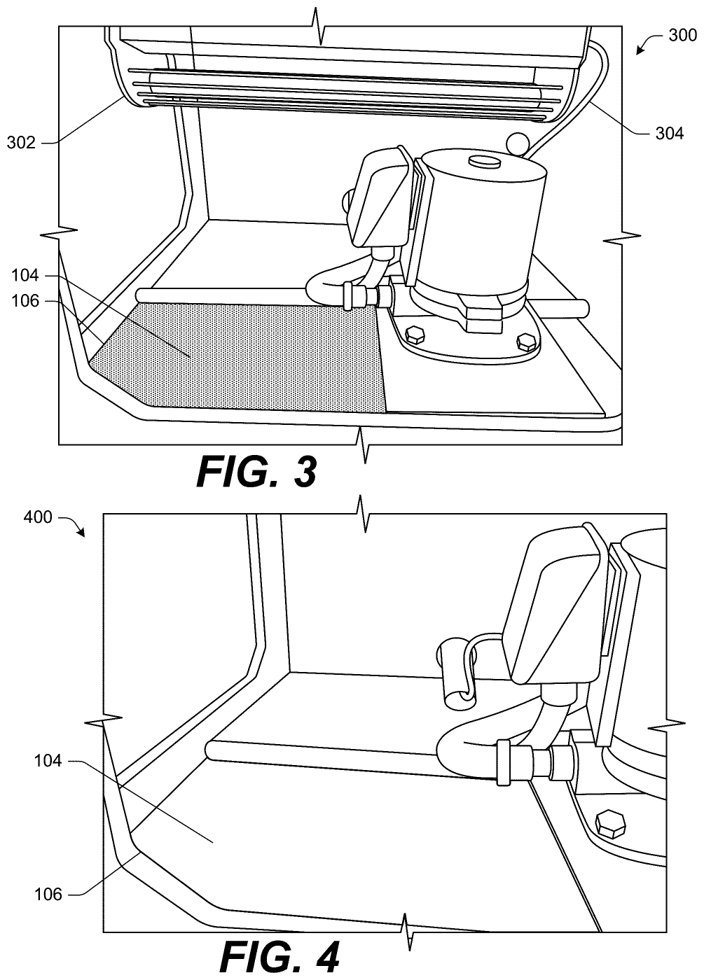

FIG. 3 is an example diagram 300 that depicts a portion of the machine 102 depicted in FIGS. 1 and 2. In particular, the machine 102 includes the liquid 104 (e.g., the coolant) that is disposed within the reservoir 106 (e.g., the coolant reservoir). As in FIG. 2, the liquid 104 is shown to be in a darkened state, indicating that the liquid 104 is dirty, old, contaminated, is of poor quality and/or color, is in poor condition, has a unpleasant odor, is in need of cleaning, removal, or replacement, etc. In addition, FIG. 4 shows a lamp 302 that includes one or more bulbs that emit light, such as UV light and/or UV-C light. Although a single lamp 302 is depicted in FIG. 3, any number of lamps/bulbs may be used. The lamp 302 is suspended above the liquid 104 and the reservoir 106 such that the lamp may emit light directed towards the liquid 104 for the purpose of sanitizing, decontaminating, cleaning, enhancing/improving the color, improving the condition or quality, etc. the liquid 104. The lamp 302 may emit light towards the liquid 104 for a sufficient duration of time in order improve the quality, cleanliness, condition, odor, color, etc. of the liquid 104. As a result, the liquid 104 within the reservoir 106 need not be removed and/or replaced and the machine 102 may continue functioning in its intended state. Also shown is a power source 304 for the lamp 302 so that the lamp 302 may receive electrical power such that the bulbs of the lamp(s) 302 may emit the light. Although the lamp 302 is shown to be suspended above the liquid 104/reservoir 106, it is contemplated that any number of lamps 302 may be disposed any position, surface, and/or orientation in association with the machine 102. Since the liquid 104 is shown to be in a darkened stated, the lamp(s) 302 have yet to emit light towards the liquid 104 in order to improve the quality, cleanliness, condition, odor, color, etc. of the liquid 104.

As described herein, the light emitted by the lamp(s) 302 may include UV light, UV-C light, and any other type of light that is capable of killing/eliminating pathogens (collectively referred to as “light”). Such pathogens may include viruses, fungus, bacteria, DNA, RNA, drugs (e.g., narcotics opioids, fentanyl, methamphetamines, etc.), and other harmful pathogens. Moreover, the lamp(s) 302 may be directly mounted or coupled to a surface of the machine 102 (an upper surface or a side surface), or may be part of a device. For the purposes of this discussion, the device may be mounted/coupled to a surface of the machine 102 or may include one or more arms or legs that support the lamp(s) 302. For instance, the arms/legs of the device may support the device such that the device is positioned over the object, liquid 104, substance, surface, etc. to be sanitized or disinfected. Regardless of the size, shape, or configuration of the device, the device may be made of any material, such as metal (e.g., aluminum, steel, etc.), plastic, wood, etc.

Regardless of whether the lamp(s) 302 are part of a device (or not), the period of time in which the lamp(s) 302 are powered on and emit light towards the liquid 104, object, substance, surface, etc. may be predetermined, manually set, or adjustable. The lamps 302 may also have some type of protective surface or a lamp assembly, such as a housing, a shield, or a cage, that prevents an object making contact with the lamps 302 while the lamps 302 are on (or are still hot after use). Such protective surface may prevent burns by a user, damage to an object that comes in contact with the lamps 302, damage to the machine 102 or any component of the machine 102, and potential fire hazard/risks.

FIG. 4 is an example diagram 400 that depicts a portion of the machine 102 depicted in FIGS. 1-3. In particular, the machine 102 includes the liquid 104 (e.g., the coolant) that is disposed within the reservoir 106 (e.g., the coolant reservoir). In contrast to FIG. 3, the liquid 104 is shown to be in a lightened state, indicating that the liquid 104 is in good quality, good condition, has been sanitized/disinfected/clean, lacks an unpleasant odor, has good color (or a color consistent with the original color of the liquid 104), etc. The embodiment illustrated in FIG. 4 depicts the liquid 104 in the reservoir 106 after the lamp(s) 302 have emitted light towards the liquid 104 for a period of time. As a result of the emitted light, pathogens within the liquid 104 have been eliminated or destroyed (or at least lessened), the quality or condition of the liquid 104 has been improved, the odor of the liquid 104 has improved, and/or the color of the liquid 104 has been improved. After exposing the liquid 104 to the light emitted by the lamp(s) 302, the machine 102 can be operated in its intended manner and the liquid 104 need not be removed and/or replaced.

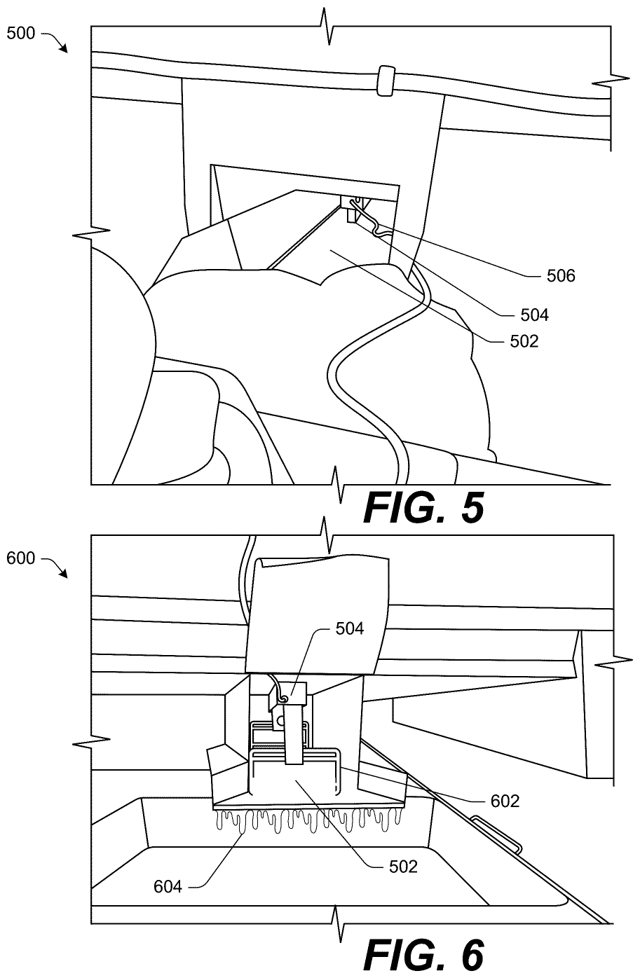

FIG. 5 is an example diagram 500 that depicts a device that emits light within a machine. For the purposes of this figure, the machine 102 may include a coolant trough 502 in which the device 504 is disposed, although the device 504 may be disposed in any location, position, orientation, and/or configuration within, external to, or otherwise associated with the machine 102. Also illustrated is a power source 506 that supplies electric power to the device 504 and, more particularly, provides electric power to one or more lamps that are disposed on the device 504. Although no liquid or coolant is currently disposed in, or flowing through, the coolant trough 502, the liquid/coolant within the coolant trough 502 may be exposed to light emitted by the lamp(s) of the device 504 to clean, sanitize, disinfect, improve the condition/quality of, improve the color of, improve the odor of, etc., the liquid/coolant. Additional details regarding the device 504 is discussed below with respect to FIG. 6.

FIG. 6 is an example diagram 600 that depicts the device as illustrated in FIG. 5. For instance, the machine 102 includes a coolant trough 502 and the device 504 is disposed or positioned within the coolant trough 502. Instead of the device 502 being mounted or disposed on an inner top or side surface of the coolant trough 502, the device 502 includes one or more legs 602 that allow the device 502 to be placed within the coolant trough 502. The one or more legs 602 of the device 502 allow the device 502 to be placed on a bottom surface of the coolant trough 502. This bottom surface of the coolant trough 502 may be where liquid 604 resides and/or is flowing through. The liquid 604 may be of any type, such as a coolant. As the liquid 604 resides within or flows through the coolant trough 502, one or more lamps of the device 502 may emit light in a downward direction towards the liquid 604. The light, such as UV light or UV-C light, may eliminate, destroy, reduce, etc. pathogens included within the liquid 604. Instead, or in addition, the light may improve the condition/quality of the liquid 604, improve the odor of the liquid 604, and/or improve the color of the liquid 604 such that the resulting color is the same as, or is similar to, an original color of the liquid 604. As a result of the liquid 604 being exposed to the light for a period of time, the liquid 604 may be cleaned, sanitized, improved, etc. and need not be removed and/or replaced. Such a process reduces or eliminates time to remove/replace the liquid 604, eliminates the cost of new liquid 604, allows the machine 102 to operate more efficiently, and/or reduces wear and tear on the machine 102.

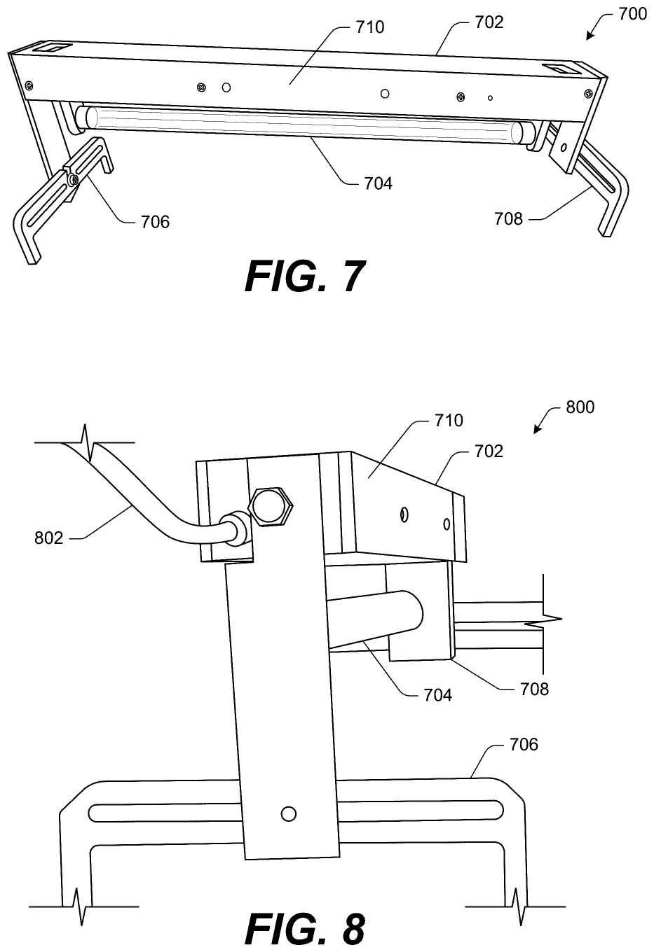

FIG. 7 is an example diagram 700 of a device 702 that emits light in order to disinfect, sanitize, improve the condition/quality of, improve the color of, improve the odor of, etc., a liquid, substance, object, or surface. The device 702 may be the same device as depicted in FIGS. 5 and 6 (or a similar device), or may be a different device. The device 702 includes one or more lamps 704 that emit light (e.g., UV light, UV-C light, etc.), and one or more legs, such as a first leg 706 and a second leg 708. The body of the device 702 in which the lamp(s) 704 is/are disposed may be referred to as an arm 710. The lamp(s) 704 may emit light in any direction, including downwards towards an object, surface, liquid, substance, etc. that is underneath the device 702. The leg(s) of the device 702 (e.g., first leg 706 and second leg 708) may support the device 702 such that the device 702 may be placed on (and rest on) a surface, such as a surface within a machine. The legs of the device 702 may cause a distance between the lamp(s) 704 of the device 702 and the object, surface, liquid, substance, etc. to be exposed to the light emitted by the lamp(s) 704. The device 702 may include any number of lamps 704 that can be disposed on any surface of location of the device 702. The device 702 may also have any number of legs and any number of arms 710. If the device 702 includes multiple arms 710, the arms 710 may be connected to one another via a pivot (or pivot point), which may allow the arms 710 to rotate, pivot, bend, turn, etc. via/around the pivot. As a result, the device 702 could have different configurations and could bend, rotate, extend, etc. such that the lamp(s) 704 could emit light in different directions. The extent to which the arms 710 are rotated or bent may be based on the surface, object, liquid, substance, etc. that is to be exposed to the light emitted by the lamp(s) 704 and/or the machine 102 in which the device 702 is used in association with. Provided that the device 702 has multiple arms 710, each arm 710 may have no lamps 704, a single lamp 704, or multiple lamps 704. The lamps 704 may be permanently affixed to the device 702 (potentially the arm(s) 710 of the device 702) or may be detachably coupled to the device 702 (potentially the arm(s) 710 of the device 702). In some embodiments, the device 702 may have one or more handles that allow the device 702 to be placed in a position/location, moved between positions/locations, and/or transported after use.

As discussed, the legs 706 and 708 allow for a distance between the lamp(s) 704 of the device 702 and the object, surface, liquid, substance, etc. that is to be exposed to the light emitted by the lamp(s) 704. As shown, although any number of legs 706/708 may be present, the device 702 may have two legs 706/708, which maintain contact with the surface(s) of the object/surface/liquid/substance and allow the device 702 to be held in place while the lamp(s) 704 apply light towards the object/surface/liquid/substance. The legs 706/708 may be of any shape, size, width, length, and thickness, may be made of any material, and may be disposed at any location of the device 702 such that the device 702 is able to remain stationary while the lamp(s) 704 of the device 702 are emitting light. The legs 706/708 may also be adjusted in any direction or angle (e.g., upwards, downwards, sideways, etc.) in order for the device 702 to be positioned over, underneath, to the side of, etc. the object/surface/liquid/substance and in order for the device 702 to be in a suitable position to apply light to the object/surface/liquid/substance. For instance, the legs 706/708 may be adjusted based on the size, shape, configuration, etc., of the object/surface/liquid/substance.

Once the device 702 is in a suitable position/place to emit light towards the object/surface/liquid/substance, the lamp(s) 704 may be powered on in various different manners. As described and illustrated elsewhere, the lamp(s) 704 may be powered on via a power cord that is connected to a power source of the machine 102 or is routed outside of the machine 102. Regardless of the object/surface/liquid/substance to be sanitized/disinfected, the power cord may be plugged into any available power source, such as a wall outlet, possibly via an extension cord. In other embodiments, the lamp(s) 704 may be powered via one or more batteries (rechargeable or not) that are separate from another power source. An inverter may also be used as a power source for the lamp(s) 704. Thus, the system may be powered by the battery of the machine 102 itself.

Once the device 702 is connected to a power source, the lamp(s) 704 may emit light towards the object/surface/liquid/substance for a suitable amount of time to disinfect, sanitize, improve the quality/condition of, improve the color of, etc. the object/surface/liquid/substance. The device 702 may have some type of input mechanism (e.g., a switch, button, lever, etc.) that a user may actuate in order to turn on/off the lamp(s) 704. The amount of time in which the light is applied to the object/surface/liquid/substance may vary (e.g., 10 seconds, 30 seconds, 1 minute, 2 minutes, etc.). As stated above, the lamp(s) 704 may be powered on/off by a user or the lamp(s) 704 may be powered on for a predetermined amount of time. As described in additional detail, the user may specify the predetermined amount of time via an input mechanism associated with the device 702. In other embodiments, the lamp(s) 704 may be powered on/off and the time in which the light is applied may be controlled via a remote control or a mobile application residing on a device (e.g., a mobile telephone, a tablet device, a desktop/laptop computer, etc.) different than the device 702. Moreover, the device 702 may be associated with one or more sensors that may detect when an object/surface/liquid/substance is underneath the device 702. Upon the sensor(s) receiving such sensor data, the lamp(s) 704 may be powered on. When the sensor(s) cease receiving such sensor data, the lamp(s) 704 may be powered off. Moreover, the sensors may also detect an orientation of the device 702 such that the lamp(s) 704 may be powered off if the orientation of the device 702 changes more than a threshold amount. This may occur if the device 702 shifts or slips as the lamp(s) 704 are applying light to the object/surface/liquid/substance.

As described herein, the device 702 may have any number of lamps 704, and the device 702 depicted in FIG. 7 includes a single lamp 704. In the embodiment depicted in FIG. 7, the lamp 704 may be disposed directly underneath the arm 710. If the device 702 includes multiple lamps 704, the lamps 704 may be disposed on opposite sides of the arm 710. The lamp(s) 704 may be configured to emit light at a wavelength outside of the visible spectrum that disables, breaks down, and/or destroys pathogenic organisms (e.g., bacteria, viruses, drugs, etc.), DNA, RNA. For instance, the lamp(s) 704 may be germicidal UV lamps. The lamp(s) 704 may be housed in lamp housings to provide directional application of the light to the object/surface/liquid/substance, and the lamp housings may prevent harm/damage to users of the device 702 and/or the object/surface/liquid/substance. The lamp housings may provide a direction for the lamp(s) 704 to emit light, thereby assisting in the application of light to the object/surface/liquid/substance. The lamp housings may also prevent at least a portion of the light emitted from the lamp(s) 704 from being emitted in a direction away from the object/surface/liquid/substance that is to be exposed to the light.

As described elsewhere, the lamps referenced throughout this disclosure may emit UV light, UV-C light, etc. that is sufficient to eliminate or destroy pathogens, bacteria, viruses, and so on. This may improve the condition, quality, color, odor, cleanliness, etc. of the object/surface/liquid/substance that is exposed to the light. The size of the lamps may vary such that the frequency and intensity of light output can be adjusted. That is, the size, type, and position of the lamps may vary to emit light of a sufficient intensity at varying wavelengths. An example wavelength may be 254 nanometers, which is highly damaging to nucleic acids and other pathogens, viruses, bacteria, etc., when they are exposed to light having that particular wavelength. However, other wavelengths of light may also be utilized to disinfect and/or sanitize an object/surface/liquid/substance that is exposed to the light. The duration or amount of light emitted towards an object/surface/liquid/substance may be dependent upon the variance of the lamps (e.g., size, type, distance between lamp and the object, surface, liquid, substance, etc.).

In some embodiments, the lamp(s) 704 may be detachably affixed/coupled to the arm(s) 710 of the device 702 such that the lamp(s) 704 may be moved to different locations, shifted, rotated, moved to a different angle, etc. For instance, a lamp 704 associated with an arm 710 of the device 702 may be moveable and/or rotatable such that the lamp 704 may still be coupled to the arm 710, but the lamp 704 may be able to emit light in different directions. In order to make the lamps 704 moveable and/or rotatable, the lamps 704 may be affixed to the arm 710/device 702 via rails, brackets, or any other coupling mechanism that allows the lamps 704 to move or allows the direction of the emitted light to be adjusted. This may allow the lamps 704 to be focused on the object/surface/liquid/substance that is to be exposed to the light based on the size, type, shape, etc. of the object/surface/liquid/substance. A frequency or wavelength of light emitted by the lamps 704 may also be adjusted (e.g., increased, decreased, etc.) prior to, or during, application of the light to the object/surface/liquid/substance. The lamp(s) 704 may be removed from the device 702, or additional lamps 704 may be added to the device 702. The bulbs of the lamps 704 may also be removed/replaced in the event of damage, breakage, malfunction, etc.

As stated above, in some embodiments, the device 702 may include one or more sensors that detect the object/surface/liquid/substance. The sensor(s) may include an active or passive infrared sensor, a microwave sensor, an area reflective sensor, an ultrasonic sensor, a photo optic motion sensor, or any other type of sensor that is configured to collect sensor data that indicates that an object/surface/liquid/substance has been detected within a threshold distance from the device 702. The device 702 may include any number of sensors and the sensor(s) may be positioned/configured on any portion of the device 702, such as the arm(s) 710, the lamp(s) 704, the legs 706/708, and so on. In response to the sensor(s) detecting the object/surface/liquid/substance, the device 702 may send a signal (e.g., audio, text, visual indicators) indicating that the device 702 is in a position to initiate disinfection and/or sanitization of the object/surface/liquid/substance. In other embodiments, once the sensor(s) detect the object/surface/liquid/substance, or once the object/surface/liquid/substance is determined to be at or within a threshold distance from the sensor(s) (e.g., 6 inches 12, inches, etc.), the device 702 may be powered on and the lamp(s) 704 of the device 702 may begin emitting light directed towards the object/surface/liquid/substance.

In various embodiments, a timer and a display may be located on the device 702 or may be accessible via a website or mobile application that is associated with the device 702 and that is presented via a user device (e.g., a mobile telephone, a tablet device, a laptop or desktop computer, a display, etc.). Prior to activating the lamp(s) 704, a timer may count down or count up to a predetermined sanitization time. For instance, when the device 702 is powered on, when the device 702 is placed in a suitable location, and/or when the object/surface/liquid/substance is detected, a time counting down from a predetermined sanitization time may begin. In some instances, upon the predetermined sanitization time being reached (e.g., light has been emitted towards the object/surface/liquid/substance for the predetermined sanitization time), an audible cue may be emitted from a speaker and/or another audio device to indicate the predetermined sanitization time has been reached. Alternatively, a visual cue may be displayed via the display that indicates that the predetermined sanitization time has been reached. The predetermined sanitization time may be a time that represents a standardized amount of time that an object/surface/liquid/substance should spend under light (e.g., UV light UV-C light) to meet a threshold sanitization level. The threshold sanitization level may be a predetermined sanitization level associated with removing at least a majority of (or a different level, such as 90%, 95%, 99%, etc.) potentially harmful pathogens. In some instances, a timer may be coupled to the device 702 or may be displayed via the mobile application. An operator of the device 702 may utilize the timer to determine a length of time the object/surface/liquid/substance is exposed by the light emitted by the lamp(s) 704 of the device 702.

At any location on the machine 102 and/or the device 702, the machine 102 and/or the device 702 may include a control panel that is used to control operations associated with the device 702. The control panel may be affixed to the machine 102 and/or the device 702 and include a user interface (or a graphical user interface), one or more buttons, sliders, levers, switches, etc. Using the control panel, an operator of the device 702 may turn on/off the lamp(s) 704 of the device 702, specify a duration in which the lamp(s) 704 are to emit light directed to the object/surface/liquid/substance, adjust a frequency or wavelength of light emitted by the lamp(s) 704, and so on. That is, using the control panel, a user may cause the lamp(s) 704 to emit light for a particular period of time that will sanitize and disinfect the object/surface/liquid/substance to be sanitized/disinfected. In an alternative embodiment, or in addition to use of the control panel, the device 702 may be controlled by other means, such as a remote control or a mobile application residing on a device (e.g., a mobile telephone, a tablet device, a desktop/laptop computer, etc.) that is associated with the device 702 and that is accessible via the device of the operator. Or, the control panel may be separate from the device 702, but be connected to the device 702 via one or more electrical wires or be connected wirelessly (e.g., WiFi, Bluetooth, cellular connection, etc.).

A power source may also be included to provide power (e.g., electricity) to the lamp(s) 704. The power source may be a plug that is inserted into an outlet for electrical power. However, in other embodiments, the apparatus may be operated using other types of power, including a battery, solar power, a gas or diesel engine, propane, etc. In some instances, a single power source may supply electric power to each lamp 704 of the device 702, or different power sources may supply electric power to different lamp(s) 704 of the device 702.

In various embodiments, the device 702 may include an emergency shut-off input mechanism. An emergency shut-off may be a manual button or switch (or a selectable element actuable via the display/mobile application) that turns-off, de-activates, and/or shuts down the lamp(s) 704. For instance, the emergency shut-off may be a lever, switch, button, selectable UI element that, when manually switched or inputted by an operator of the device 702, immediately ceases application of the light by the lamps 108 of the device 702.

The power source may have an electrical power setting. For instance, the power source may be at least one of 240 volt (240 v) single phase, 240 v two phase, 240 v three phase, 110-volt single phase, or other suitable voltage and phase settings. The power source may be configured to receive electric power from an electrical producing device or system including receive electrical power via chemical energy, mechanical energy, solar energy, wind energy, geothermal energy, hydrogen energy, hydroelectric energy, and/or biomass energy. Although a power cord is described herein, it is contemplated that the device 702, and the lamp(s) 704 in particular, may receive electrical power using other types of power, including a port/charger associated with the machine 102, one or more batteries, solar power, a gas or diesel engine, a generator, propane, etc.

FIG. 8 is an example diagram 800 of the device 702 as illustrated in FIG. 7. Instead of a side view of the device 702, as illustrated in FIG. 7, FIG. 8 illustrates the device 702 from an end view. As shown, the device 702 includes one or more lamps 704, a first leg 706 and a second leg 708 that support the device 702, one or more arms 710 in which the lamp(s) 704 are disposed, and a power source 802 for providing power to the lamp(s) 704, which allow the lamp(s) 704 to emit light (e.g., UV light, UV-C light, etc.) directed towards an object, liquid, surface, substance, etc. that is intended to be exposed to the light.

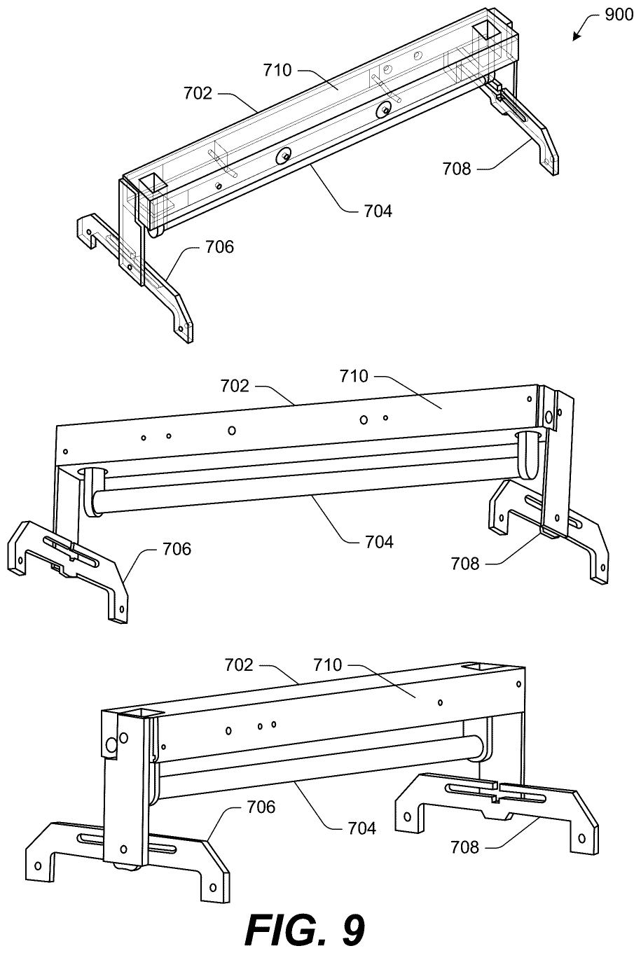

FIG. 9 illustrates an example diagram 900 of the device 702 as illustrated in FIGS. 7 and 8. As shown, the diagram 900 illustrates three different perspectives of the device 702, including a top/overhead view, an additional side view, and a view from an angle between the side view and the end view.

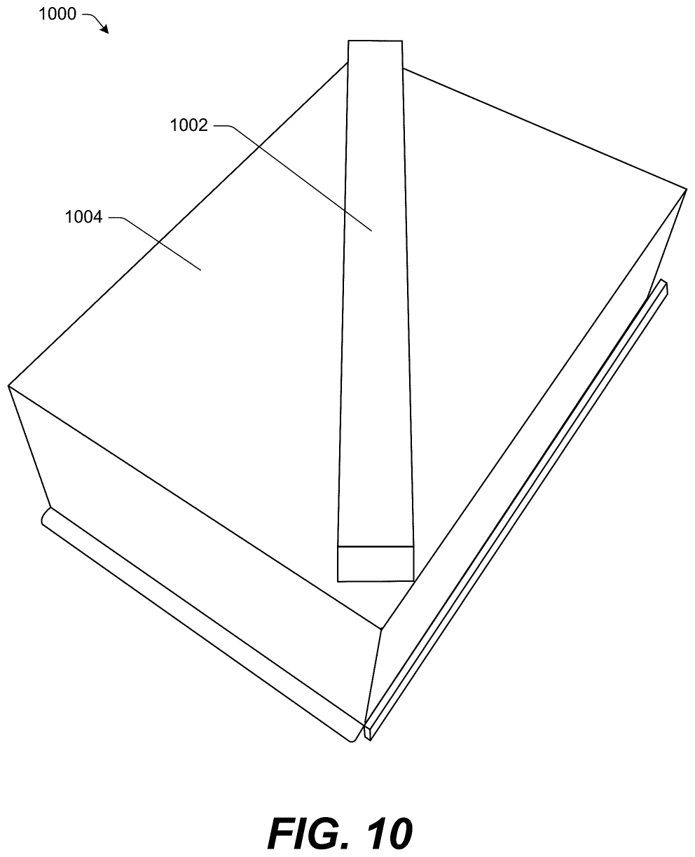

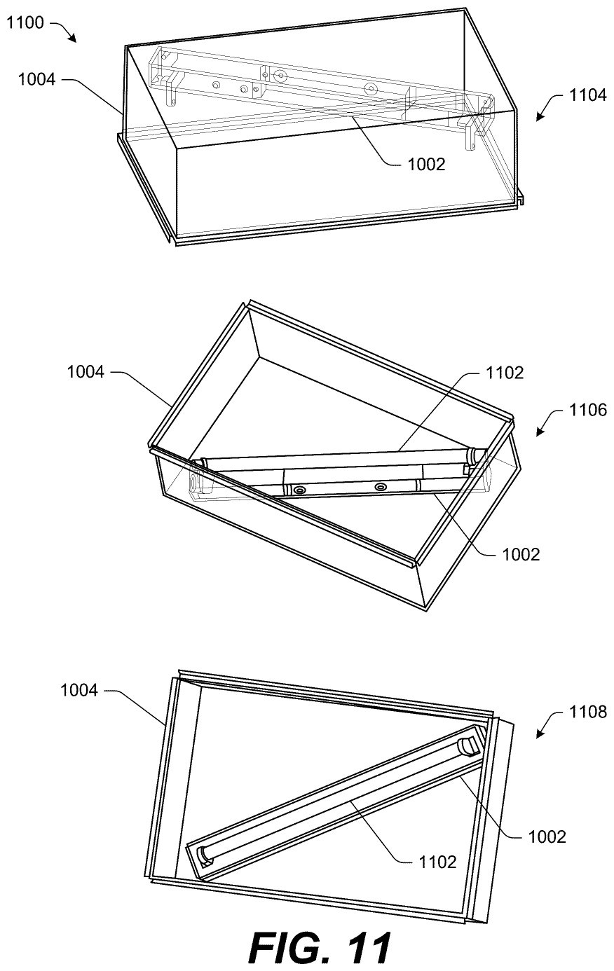

FIG. 10 illustrates an example diagram 1000 of a device utilized to emit light towards an object, surface, liquid, substance, and/or machine. As shown, FIG. 10 depicts a device 1002 and a corresponding container 1004. Instead of utilizing legs of the device 702 illustrated in FIGS. 7-9, the arm/lamp(s) assembly of the device 1002 may be enclosed within a container, box, bag, etc. (collectively referred to herein as “container 1004”) that is to be used to sanitize/disinfect an item, object, surface, substance, liquid, an entirety of a machine, or a portion of a machine. As shown in FIG. 11, the device 1002 may be included within an interior of the container 1004. However, instead of the device 1002 being affixed to an interior surface of the container 1004, the container 1004 may alternatively have a cut-out, void, or hole consistent with the size/shape of the device 1002 such that the lamp(s) of the device 1002 is/are able to emit light within the interior of the container 1004. The cut-out, void, or hole may be disposed on the top surface of the container 1004 such that the light is emitted downwards toward the item/surface/liquid/substance to be sanitized. The container 1004 may be placed over an object, liquid, substance, surface, machine etc. that is to be exposed to the light emitted by the lamp(s) of the device 1002 such that the object, liquid, surface, substance, machine, etc. is exposed to the light emitted by the lamp(s). For instance, the container 1004 may be placed over a coolant reservoir or coolant trough of a machine, such as a lathe. In other embodiments, the cut-out, void, or hole may be disposed on a side surface of the container 1004 such that the light emitted by the lamp(s) of the device 1002 is/are directed in a substantially horizontal direction towards a top surface, a side surface, and/or a bottom surface of the item/surface/liquid/substance/machine to be sanitized. In this scenario, the container 1004 may be placed to the side of the item/surface/liquid/substance/machine to be sanitized.

The container 1004 may be placed over an object, surface, liquid, substance, machine, etc. that is to be exposed to the light emitted by the lamp(s) of the device 1002. Since the container 1004 surrounds the object/surface/liquid/substance/machine, light emitted by the lamp(s) of the device 1002 may not escape the container 1004. As a result, only the intended target is actually exposed to the light emitted by the lamp(s). As described elsewhere herein, the light (e.g., UV light, UV-C light, etc.) may sanitize/disinfect, clean, improve the quality or condition of, improve the color of, etc. the object, liquid, substance, machine, etc.

FIG. 11 illustrates an example diagram 1100 of a device utilized to emit light towards an object, surface, liquid, substance, and/or machine. As opposed to fastening the device 1002 to an exterior surface of the container 1004, in the embodiment illustrated in FIG. 11, the arm/lamp(s) of the device 1002 may be attached, secured, or affixed to an internal surface of the container 1004. For example, the device 1002 may be affixed to a top interior surface (or any other interior surface) of the container 1004. In this configuration, the lamp(s) of the device 1002 may emit light towards the item/surface/liquid/substance/machine to be treated. The device 1002 being disposed within the container 1004 may prevent the light from being emitted external to the interior/cavity of the container 1004. When the container 1004 is placed over the item/surface/liquid/substance/machine to be sanitized (or disinfected or cleaned), the surfaces of the container 1004 may prevent the light from escaping the interior of the container 1004. That is, the walls and top of the container 1004 may be made of a material that is not clear, translucent, or opaque (e.g., cardboard, metal, plastic, fabric, etc.). The container 1004 may have not bottom surface such that the container can be placed over the item/surface/liquid/substance/machine to be sanitized. In some embodiments, the container 1004 may lack a side wall/surface such that the container 1004 can be placed to the side of the item/surface/liquid/substance/machine to be sanitized, cleaned, disinfected, etc. In this embodiment, the lamp(s) of the device 1002 may be disposed on any interior surface of the container 1004.

FIG. 11 shows different perspective of the device 1002 being disposed within the container 1004, where the walls and ceiling of the container 1004 are transparent for the purpose of being able to view the device 1002 within the interior of the container 1004. Diagram 1104 shows a perspective where the opening to the container 1004 is on the bottom such that the container 1004 could be placed over an object, surface, liquid, substance, machine, etc. Diagrams 1106 and 1108 show perspectives where the opening of the container 1004 is facing upwards such that the device 1002 and its corresponding lamp(s) can be viewed.

Any or every interior surface of the container 1004 may include a reflective surface that reflects light back towards the object, liquid, substance, surface, machine, etc. that is to be exposed to the light emitted by the lamp(s) of the device 1002. As a result, instead of the light being potentially directed away from the item/surface/liquid/substance/machine, the reflective surface may redirect that light back to surfaces of the item/surface/liquid/substance/machine to be sanitized/disinfected/cleaned. The reflective surface may be any type of metal or any type of polyester film having a coating of metal, such as Metallized DuraLar™, which consists of a polyester film with a thin coating of aluminum. Example metals that may be used in association with the reflective surface may include aluminum, mild steel, stainless steel, nickel, silver, chrome plated steel, anodized aluminum, aluminum foil, or any other type of metal.

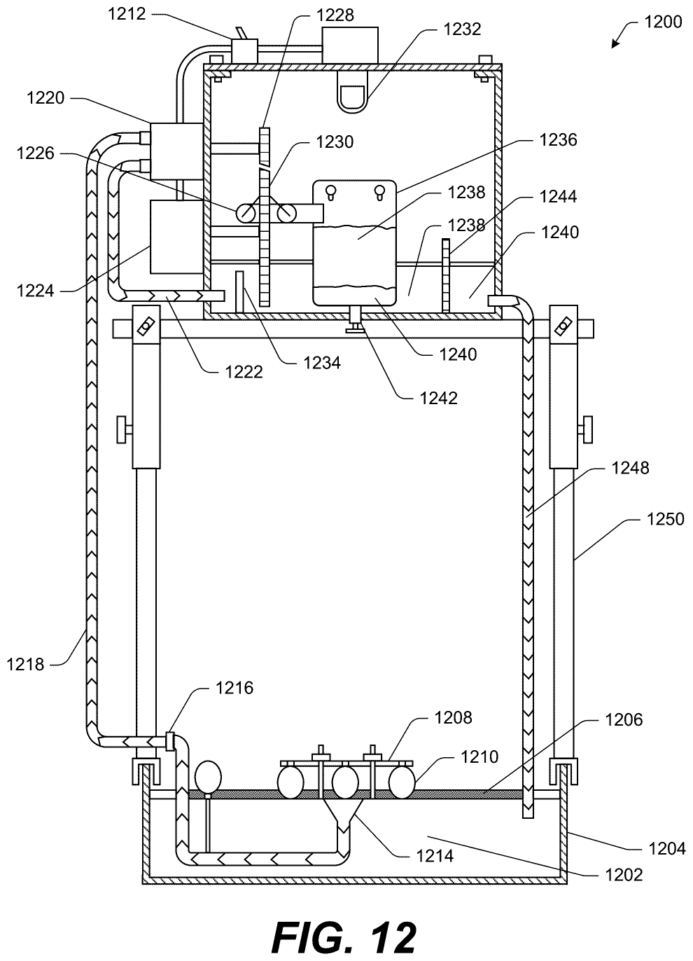

FIG. 12 illustrates an example diagram of a system 1200 configured to treat liquid associated with a machine. In particular, the system 1200, which may be referred to as a coolant decontamination unit (CDU), may receive a liquid (e.g., a coolant), expose the liquid to light (e.g., UV light, UV-C light, etc.), and return the liquid to a reservoir. The system is configured to skim a liquid, decontaminate the liquid, eliminate odors from the liquid, improve the quality/condition of the liquid, improve the color of the liquid (i.e., restoring the liquid to its original/intended color, or close to its original/intended color), and/or maintain the liquid for a wide range of machines. Such machine may include mills, lathes, drill presses, saws, CNC machines, manual machines, and so on.

Initially, liquid may be pumped from a reservoir of the machine into a device, allowing for the separation and external containment of any oil (or other substances) that may be mixed with the liquid. The liquid may continuously cycle through the device and is then returned back to the reservoir of the machine. Before the liquid is reintroduced to the machine, the liquid may undergo light exposure within the device, effectively eliminating bacteria and/or other pathogens that may cause unwanted odors and/or colors in the machine liquid. For instance, the device may have one or more lamps or bulbs that emit light that is directed towards the liquid. The device, which may be constructed with durable material (e.g., stainless steel), may include a manual skimmer timer (potentially associated with a skimmer wheel), an on/off switch for the lamp(s)/light(s), and/or an external collection container with a return hose that may collect oil or other unwanted substances that were included in the liquid. When the device is turned off, the device may automatically drain the liquid back into the reservoir of the machine. Additionally, the device may be equipped with wheels and/or a rolling stand, enabling easy mobility from one machine to another. That is, the device may treat liquid of one machine and then be transported to another machine to perform similar operations. As a result of use of the device, time, cost, and resources may be minimized by eliminating the need for extensive machine cleaning, liquid/coolant replacement, and the expense of outsourcing the removal of old, dirty, and/or unwanted liquid/coolant from a facility in which the machines are located.

As illustrated, the device may either be placed over a machine in which liquid/coolant is to be treated, or may be separate from the machine where the liquid/coolant is received by the device, treated by the device, and returned back to a reservoir of the machine. The machine may store a liquid 1202 (e.g., a coolant) within a reservoir 1204 (e.g., a coolant reservoir), where the liquid 1202 may be used by the machine, may be a byproduct of the machine, etc. Included within the liquid 1202 may be other substances 1206 (or contaminants), such as a layer of oil that resides on a top surface of the liquid 1202. At or near a top portion of the reservoir 1204 that stores the liquid 1202, the system 1200 may have a float adjustment 1208 that determines and/or measures an amount, level, or volume of the liquid 1202. Included within the float adjustment 1208 may be one or more floats 1210 that may be adjustable and that may facilitate measuring or otherwise determining the amount, level, or volume of the liquid 1202. The system 1200 may have a selectable on/off actuator 1212, which may be a button, switch, lever, and so on. As a result, of powering on the system 1200 using the on/off actuator 1212, the liquid 1202 may be pumped or otherwise routed for exposure to light (e.g., UV light, UV-C light, etc.).

Within the reservoir 1204, a liquid intake mechanism 1214 may be present, which accepts/receives the liquid 1202 and routes the liquid 1202 for light exposure. The one or more floats 1210 may allow the liquid intake mechanism 1214 to be at an appropriate level to allow the liquid 1202 (e.g., coolant, oil, etc.) to be properly pumped into the device and removed from the reservoir 1204. As shown, from the liquid intake mechanism 1214, the arrows indicate that the liquid 1202 is routed from the reservoir 1204 past a float level mechanism 1216 (e.g., a flexible union) via a first liquid transport mechanism 1218 (e.g., a tube, line, pipe, hose, etc.) that transports the liquid 1202 from the reservoir 1204 in order for the liquid 1202 to be exposed to the light. In some embodiments, the float level mechanism 1216 may allow the float(s) 1210 to remain level on the liquid 1202.

The system 1200 may also include a pump 1220 (e.g., a water pump), a water transporter mechanism 1222, such as a tube, line, pipe, hose, etc. that transports water from the pump 1220, and a skimmer motor/pump drive 1224. Such components cause water and/or the liquid 1202 to be transported throughout the system 1200. The pump 1220 may be operated via one or more gears and/or via electric power and the pump 1220 may be disposed directly within the reservoir 1204. Also included in the system 1200 may be one or more skimmer wipers 1226, gearing 1228 to drive the pump 1220, and/or a skimmer wheel/gear 1230. The skimmer motor/pump drive 1224 may cause operation of the skimmer wheel/gear 1230 and may be controlled via a timer. The skimmer motor/pump drive 1224 may or may not be a first gear that meshes with a second gear in order to operate/run the pump 1220, provided that the pump is not an electric pump. The skimmer wheel/gear 1230 may remove contaminants (e.g., oil) that have settled at the top of the liquid. As the skimmer wheel/gear 1230 rotates, it dips into the liquid and the contaminants (e.g., oil) and potentially some of the liquid (e.g., coolant) sticks or adheres to the side of the skimmer wheel/gear 1230. As the skimmer wheel/gear 1230 rotates into the skimmer wiper(s) 1226, the skimmer wiper(s) 1226 scrape the liquid (e.g., oil and possibly coolant) such that the liquid collects within an exposure reservoir 1236 (referenced below).

The system 1200 may include one or more lamps 1232 that emit light (e.g., UV light, UV-C light, etc.). The system 1200 may also include a one or more baffles 1234 that causes the liquid 1202 and/or water to flow in a particular direction. The baffle(s) 1234 may also help keep the contaminants (e.g., the oil) on the side of the device that includes the skimmer wheel/gear 1230, and helps keep the liquid (e.g., the coolant) on the side of the device that includes the lamp(s) 1232 and the light exposure. The liquid 1202 and/or water is directed into the exposure reservoir 1236 that includes the contaminants 1238 (e.g., oil) and the liquid 1240 to be treated (e.g., coolant). The one or more lamps 1232 may emit light directed towards the contaminants 1238 and the liquid 1240 included in the exposure reservoir 1236 in order to clean, sanitize, disinfect, improve the color of, remove odors from, improve the quality/condition of, the liquid 1240. Upon being exposed to the light emitted by the lamp(s) 1232 for a period of time, the liquid 1240 may be released from the exposure reservoir 1236 by use of a valve 1242 associated with the exposure reservoir 1236. As a result, the contaminants 1240 that are external to, or outside of, the exposure reservoir 1236 and the clean/sanitized liquid 1240 that has been released from the exposure reservoir 1236 may be separated using a divider 1244, such as a screen. The clean/sanitized liquid 1240 may then be routed 1248 back to the reservoir 1204 for subsequent use. In some embodiments, the system 1200 may include adjustable legs, an adjustable stand, and/or wheels in order to move or transport the system 1200.

In other embodiments, the exposure container 1236 may instead be a container (e.g., a container external to the device) that holds the liquid (e.g., oil and some coolant) that comes off the skimmer wheel/gear 1230 via the skimmer wiper(s) 1226. The contaminants within this external container (e.g., oil) may settle towards the top of the external container. The valve 1242 may be opened to allow the liquid (e.g., the coolant), and not the contaminants (e.g., the oil), to return back into the reservoir 1204 and closed/turned off to keep the contaminants within the external container. Once the external container becomes full (or close to full) of the contaminants, the contaminants may be disposed of elsewhere.

In some embodiments, the portion of the system 1200 that includes the reservoir 1204 is the machine and the portion of the system 1200 that includes the lamp(s) 1232 and the exposure reservoir 1236 is the device/CDU. In this scenario, the liquid 1202 (e.g., coolant) and contaminants 1206 (e.g., oil) may be initially skimmed from the reservoir 1204 (e.g., coolant reservoir). Then, the liquid 1202/contaminants 1206 may be routed/pumped into the device/CDU (e.g. UV light area with the skimmer wheel(s)/gear(s) 1230). The contaminants 1238 may be skimmed and collected (to be discarded elsewhere) and the treated liquid 1240 (e.g., treated coolant) and the treated liquid 1240 will be returned back into the original reservoir 1204. The liquid 1202 may be continually cycled throughout the system, which may allow the light emitted by the lamp(s) 1232 to contact an entirety of the liquid/coolant 1202 over time.

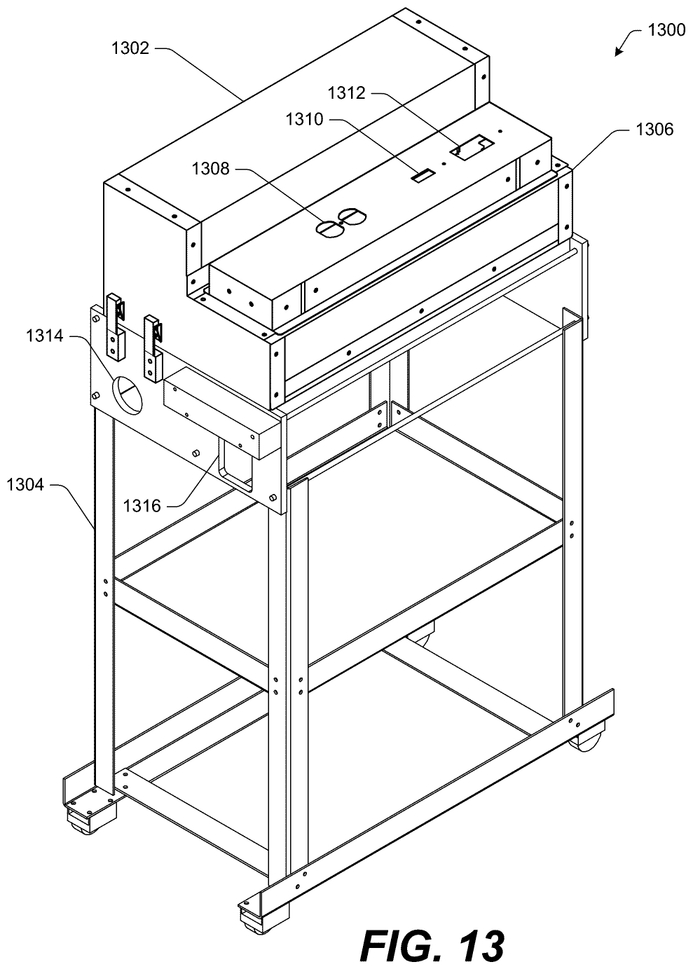

For the purpose of this discussion, the system 1200 illustrated in FIG. 12 and described above may correspond to the systems depicted in, and described with respect to, FIGS. 13-15.

FIG. 13 is an illustrative diagram 1300 of the device/CDU referenced with respect to FIG. 12. The device 1302 may include a lower portion 1304, such as a stand, legs, wheels, etc., that allows for movement or transport of the device 1302. The device 1302 also may include an upper portion 1306 that facilitates the treatment of liquid (e.g., coolant) using one or more lamps that emit light (e.g., UV light, UV-C light, etc.) directed towards the liquid. The upper portion 1306 of the device 1302 may include one or more power outlets or sources 1308 that facilitate operation of the device 1302, a selectable actuator 1310 (e.g., a button, switch, lever, etc.) that causes the device 1302 to turn on and off or causes the lamp(s) of the device 1302 to turn on/off, and/or a skimmer wheel 1312 (e.g., a skimmer timer) that is selectable/adjustable to control the rate of the liquid flowing through the device 1302, the duration in which the device 1302 is operating, and/or the amount of liquid, coolant, contaminant, etc. being collected. In certain embodiments, the liquid/coolant to be treated by the device 1302 may flow or be routed into the device 1302 (e.g., pumped into the device 1302) via a first opening 1314 and the treated liquid/coolant may exit the device 1302 via a second opening 1316. However, the direction of the liquid/coolant flowing into and out of the device 1302 may be switched and the openings may be disposed at any location of the device 1302.

In some embodiments, the skimmer wheel 1312 may be on a timer system such that the device 1320 does not operate continuously. Moreover, the one or more power outlets/sources 1308 may power both a skimmer motor and a pump that are included in the upper portion 1306 of the device 1302.

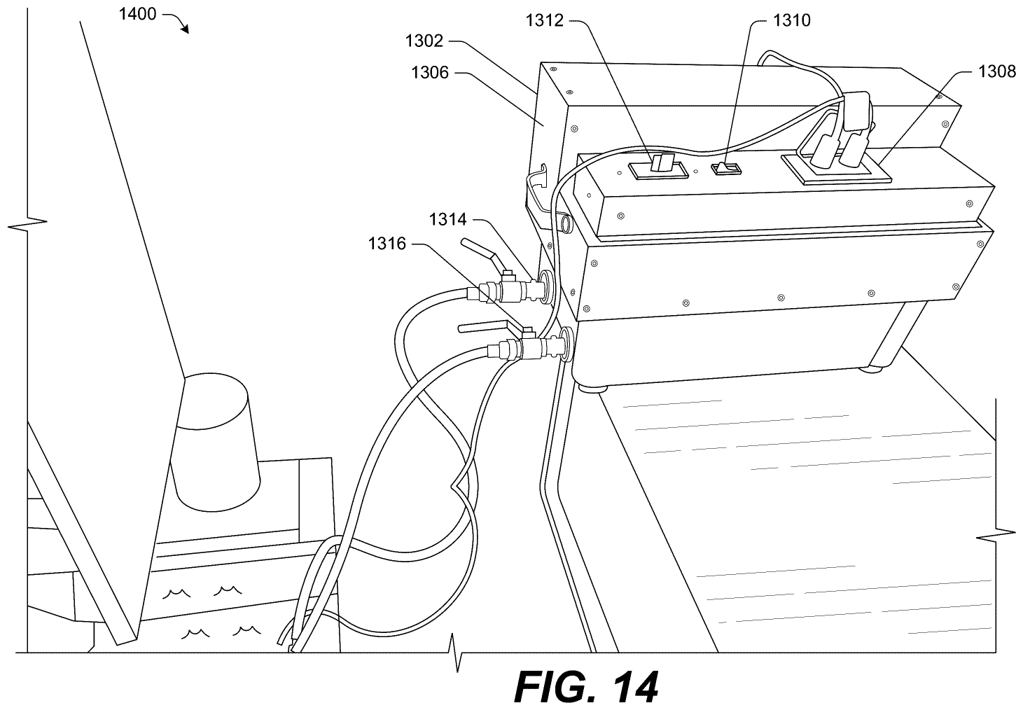

FIG. 14 is an example diagram 1400 of the device 1302 as illustrated in, and as described with respect to, FIGS. 12 and 13. As shown, the liquid/coolant to be treated by the device 1302 is pumped or routed from a reservoir of a machine into the device 1302 via one or more lines, hoses, tubes, etc. In particular, the liquid/coolant may enter the device 1302 via the first opening 1314 and/or the second opening 1316 such that the liquid/coolant is within the upper portion 1306 of the device 1302. Once the liquid/coolant enters the device 1302 (e.g., the upper portion 1306 of the device 1302), the liquid/coolant begins to fill an area, compartment, or reservoir within the upper portion 1306 of the device 1302. As the liquid/coolant is being pumped (or otherwise routed) into the device 1302, the liquid/coolant may continue to fill the compartment/area/reservoir that stores the liquid/coolant prior to the liquid/coolant being treated by the light emitted by the lamp(s) of the device 1302. Any contaminants within the liquid/coolant (e.g., oil) may begin to settle towards the top of the liquid level within the compartment/reservoir.

The upper portion 1306 of the device 1302 may include a baffle or divider that separates the compartment/reservoir in which the liquid/coolant is pumped/routed into from another area of the upper portion 1306 of the device 1302. The baffle/divider may have an opening, void, or cut-out near the bottom of the baffle/divider. Accordingly, the baffle/divider may allow a bottom portion of the liquid/coolant that is below the contaminants/oil, but not the contaminants/oil, to traverse to this other area of the device 1302. Once the contaminants/oil is settled on the top layer of the liquid/coolant that is included in the compartment/reservoir, a user of the device 1302 may actuate (e.g., turn on) the skimmer wheel 1312 of the device 1302. As a result, the skimmer wheel 1312 will rotate and begin collecting the contaminants/oil as the skimmer wheel 1312 spins at a rate through the liquid/coolant. The contaminants/oil that are collected on one or both sides of the skimmer wheel 1312 may come into contact with one or more scrapers of the device 1302. The collected contaminants/oil is then funneled or output into a transport mechanism (e.g., a pipe, tube, hose, etc.) and is deposited outside of the device 1302 for collection. The collected contaminants/oil may be collected within container 1236, as described above with respect to FIG. 12. Such contaminants/oil may then be discarded or used for other purposes.

Meanwhile, the liquid (and not the contaminants/oil) that has traversed into the other area of the upper portion 1306 of the device 1302 though the opening, void, or cut-out associated with the baffle/divider may be exposed to light (e.g., UV light, UV-C light, etc.) emitted by the lamp(s) of the device 1302. The device 1302 may have any number of lamps that emit light directed towards the liquid/coolant in order to clean, sanitize, disinfect, improve the odor or, improve the quality/condition of, improve the color of, etc. the liquid/coolant.

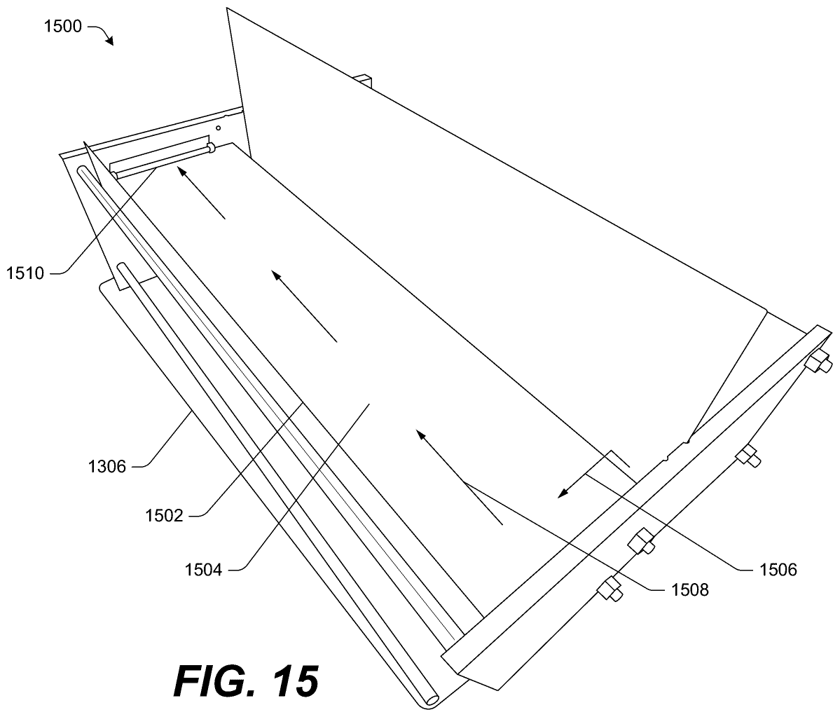

As will be explained in additional detail with respect to FIG. 15, the liquid/coolant may traverse across the upper portion 1306 of the device 1302 the lamp(s) may emit light downwards towards the liquid/coolant as it is traversing. The liquid/coolant may be at a relatively shallow depth while traversing across the upper portion 1306 of the device 1302 such that an entirety, or at least a significant portion, of the liquid/coolant is exposed to the light. The lamp(s) may be of any number (e.g., two lamps) and may be disposed in the upper portion 1306 of the device 1302 such that they are in relative close proximity to the liquid/coolant as it is traversing. As a result, the light emitted by the lamp(s) may better penetrate the liquid/coolant. The liquid/coolant may traverse across the upper portion 1306 of the device 1302 while being exposed to the light emitted by the lamp(s) towards an exit of the device 1302. For instance, the treated/cleaned liquid/coolant may exit the device 1302 via the first opening 1314 and/or the second opening 1316 and be routed (e.g., by gravity) or pumped back to the machine for subsequent use by the machine. In other embodiments, the lamp(s) of the device 1302 may emit light directed towards the liquid/coolant while the liquid/coolant is situated in any compartment, area, or reservoir of the upper portion 1306 of the device 1302.

In certain embodiments, the device 1302 may also include some type of device or mechanism to prevent the liquid within the device 1302 from overflowing (i.e., liquid overflow prevention). The mechanism/device may be a mechanical device or an electrical device. If the overflow mechanism/device is mechanical, the device 1302 may have an opening that is in proximity to a location/area at which the liquid is stored after being received from the machine, or a location/area at which the liquid is exposed to the light emitted by the lamp(s). If the level of the liquid reaches the opening (e.g., the liquid overflows out of its area), the liquid may enter the opening and be routed back to the reservoir/area at which the liquid is stored within the device 1302.

Provided that the overflow mechanism/device is electrical in nature, the device 1302 may have an electric float or electric float switch that can be wired to shut off a pump from pumping the liquid into the device 1302 from the machine. When the liquid reaches a certain level within the device 1302, as determined by the electric float/electric float switch, the pump may be turned off, which prevents additional liquid from the machine to be pumped into the device 1302. The electric float/float switch may be disposed at any location in association with the device 1302, such as being mounted inside of the device 1302 on a side of the skimmer wheel. Once the level of the liquid is below a threshold level, the pump may be turned back on, which may cause additional liquid to be pumped into the device 1302 from the machine.

FIG. 15 is an example diagram 1500 of the device 1302 as illustrated in, and as described with respect to, FIGS. 12-14. In particular, the upper portion 1306 of the device 1302 includes an area 1502 in which the liquid/coolant 1504 traverses across while being exposed by light (e.g., UV light, UV-C light, etc.) emitted by one or more lamps of the device 1302. The liquid/coolant 1504 may enter the area 1502 at a first location 1506 and may traverse across the area 1502 in a direction 1508 towards an endpoint 1510 of the area 1502. As the liquid/coolant 1504 is traversing across the area 1502 in the direction 1508 towards the endpoint 1510, the liquid/coolant 1504 may be exposed to the light emitted by the lamp(s). Once the liquid/coolant 1504 reaches the endpoint 1510, the treated/cleaned liquid/coolant 1504 may be fed, routed, or pumped back to the machine for subsequent use.

The area 1502 in which the liquid/coolant 1504 is exposed to the light emitted by the lamp(s) may be a relatively thin spillway. The depth of the liquid/coolant 1504 may vary, but may be a depth such that the light emitted by the lamp(s) is able to penetrate the entire depth of the liquid/coolant 1504 as the liquid/coolant 1504 is traversing across the area 1502. For instance, although any depth of the liquid/coolant 1504 is contemplated herein, the depth may be an inch deep, ½ inches deep, ⅜ inches deep, 1/32 inches deep, and even a lesser depth. In some embodiments, the liquid/coolant 1504 may traverse along the length of two lamps (e.g., alongside one another) to ensure that light exposure is maximized. As stated above, the thin layer of liquid/coolant 1504 may traverse across the area 1502 at a relatively slow rate and exit the area 1502 at the endpoint 1510.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A device comprising:
a lower portion that is configured to facilitate movement of the device from a first location to a second location; and
an upper portion that is supported by the lower portion, the upper portion including:
a first opening in which a coolant is received from a reservoir of a machine that is different than the device;
a first area in which the coolant is collected after entering the first opening;
a second area in which a portion of the coolant flows to from the first area;
a baffle that at least partially separates the first area from the second area;
a third area at which the portion of the coolant traverses in a direction from a first end of the third area to a second end of the third area that is opposite the first end;
one or more lamps that emit light directed towards the portion of the coolant while the portion of the coolant traverses in the direction across the third area; and
a second opening, adjacent to the second end, at which the portion of the coolant exits the third area and is returned to the machine.

2. The device as recited in claim 1, wherein the baffle includes an opening, void, hole, or cut-out that allows the portion of the coolant to flow from the first area to the second area.

3. The device as recited in claim 2, wherein the void, the hole, or the cut-out is located at a first bottom portion of the baffle and the portion of the coolant flows to the second area from a second bottom portion of the coolant within the first area.

4. The device as recited in claim 1, wherein the one or more lamps include a first lamp and a second lamp that are each disposed within the third area.

5. The device as recited in claim 1, wherein the light includes ultraviolet (UV) light or UV-C light.

6. The device as recited in claim 1, wherein the coolant is transferred from the reservoir of the machine via a first transport mechanism and the portion of the coolant is returned to the machine via a second transport mechanism, the first transport mechanism and the second transport mechanism each being a hose, a line, or a tube.

7. The device as recited in claim 1, wherein the upper portion includes a skimmer wheel that is disposed in the first area that collects a second portion of the coolant that is within the first area.

8. The device as recited in claim 7, wherein the skimmer wheel is associated with a timer such that the skimmer wheel operates for a limited duration of time.

9. A device comprising:
a first opening in which a liquid is received;
a first area in which the liquid is collected after entering the first opening;
a second area at which at least a portion of the liquid traverses in a direction from a first end of the second area to a second end of the second area that is opposite the first end;
one or more lamps that emit light directed towards the portion of the liquid while the portion of the liquid traverses in the direction across the second area; and
a second opening, adjacent to the second end, at which the portion of the liquid exits the second area.

10. The device as recited in claim 9, wherein the device includes:
a lower portion that is configured to facilitate movement of the device from a first location to a second location; and
an upper portion that is supported by the lower portion and that includes the first opening, the first area, the second area, the one or more lamps, and the second opening.

11. The device as recited in claim 10, wherein the upper portion includes a skimmer wheel that is disposed in the first area that collects a second portion of the liquid that is within the first area.

12. The device as recited in claim 11, wherein the skimmer wheel is associated with a timer such that the skimmer wheel operates for a limited duration of time.

13. The device as recited in claim 9, wherein the liquid is received from a reservoir of a machine that is different than the device and the portion of the liquid is returned to the machine after being exposed to the light.

14. The device as recited in claim 9, further comprising:
a third area in which the portion of the liquid flows to from the first area; and
a baffle that at least partially separates the first area from the third area.

15. The device as recited in claim 14, wherein the baffle includes an opening, void, hole, or cut-out that allows the portion of the liquid to flow from the first area to the third area.

16. The device as recited in claim 15, wherein the void, the hole, or the cut-out is located at a first bottom portion of the baffle and the portion of the liquid flows to the third area from a second bottom portion of the liquid within the first area.

17. The device as recited in claim 9, wherein the one or more lamps include a first lamp and a second lamp that are each disposed within the second area.

18. The device as recited in claim 9, wherein the light includes ultraviolet (UV) light or UV-C light.

19. The device as recited in claim 9, wherein the liquid is transferred from a reservoir of a machine via a first transport mechanism and the portion of the liquid is returned to the machine via a second transport mechanism, the first transport mechanism and the second transport mechanism each being a hose, a line, or a tube.

20. A system comprising:
a machine that uses or outputs a liquid; and
a device that exposes the liquid to light, the device comprising:
a first opening in which the liquid is received from a reservoir of the machine;
a first area in which the liquid is collected after entering the first opening;
a second area at which at least a portion of the liquid traverses in a direction from a first end of the second area to a second end of the second area that is opposite the first end;
one or more lamps that emit the light directed towards the portion of the liquid while the portion of the liquid traverses in the direction across the second area; and
a second opening, adjacent to the second end, at which the portion of the liquid exits the second area and is routed to the machine.
